(19) United States
(12) Patent Application Publication
(10) Pub. No.: US 2018/0159940 A1
(43) Pub. Date: Jun. 7, 2018

(54) Method And Server For Managing Content Requests

(71) Applicant: Telefonaktiebolaget LM Ericsson (publ), Stockholm (SE)

(72) Inventors: Fredrik HULTKRANTZ, GOTHENBURG (SE); Tommy ARNGREN, SÖDRA SUNDERBYN (SE); Viktor GUNNARSON, GOTHENBURG (SE); Björn SANDSTRÖM, STOCKHOLM (SE)

(21) Appl. No.: 15/737,764

(22) PCT Filed: Jul. 3, 2015
(86) PCT No.: PCT/SE2015/050794

§ 371 Date: Dec. 19, 2017

(51) Int. Cl. H04L 29/08; H04L 29/06

(52) U.S. Cl. CPC H04L 67/141; H04L 67/146; H04L 2209/60; H04L 63/10; H04L 67/2842; H04L 63/0823

(57) ABSTRACT

A method for managing a content request from a Communication Device, CD, is presented. The method is performed by a cache server and comprises: receiving a request for a content from a Communication Device, CD, the request further comprising a user session token; and providing the requested content to the CD when the user session token is cached on the cache server and when the content is cached on the cache server. A corresponding cache server, computer program and computer program product are also presented.

### TECHNICAL FIELD

The invention relates to a method for managing a content request, as well as to cache server, computer program and computer program product for the same.

### BACKGROUND

Internet is today used a lot for viewing a verity of contents. The users often expect rapid download of content items, irrespective of the amount of data that needs to be download.

To facilitate downloading of content items from an application server to a user, a cache server may be used. A cache server stores previously accessed data in a volatile memory, and then provides previously stored data to subsequent requests in a rapid way. Further, some content items are only intended for a restricted subset of users. Restricted content has to be obtained from an application server applying access control logic.

A system that facilitates security-enabled content caching has been described in US 2004/0243839.

### SUMMARY

It is an object of the invention to enable improved management of content request for restricted contents with respect to unnecessary communication and access time to restricted content.

According to a first aspect, it is presented a method for managing a content request from a communication device, CD. The method is performed by a cache server and comprises the steps of: receiving a request for a content from the CD, the request further comprising a user session token; and providing the requested content to the CD when the user session token is cached on the cache server and when the content is cached on the cache server. By caching both a user session token and a requested content on the cache server, a communication device associated with a user can swiftly access restricted content with a single request.

The method may further comprise the steps of: requesting validation of the user session token at an authentication server, when the user session token is not already cached on the cache server; and caching the validated user session token on the cache server.

The method may further comprise the steps of: retrieving the content from a content server, when the content is not already cached on the cache server; and caching the retrieved content on the cache server.

The cached content may be provided with a freshness time stamp. The requested content may then be retrieved from the content server when the freshness time stamp has expired or when not already cached on the cache server.

Determination if the requested content is cached on the cache server in the step of providing may be performed after determination if the user session token is cached on the cache server in the step of providing.

The user session token may be cached on the cache server independently from the cached content on the cache server.

The CD may be a User Equipment, UE, and the cache server may be a video cache server.

According to a second aspect, it is presented a cache server configured to manage a content request from a Communication device, CD. The cache server comprises: a processor and a computer program product storing instructions that, when executed by the processor, causes the cache server to: receive a request for a content from the CD, the request further comprising a user session token; and provide the requested content to the CD when the user session token is cached on the cache server and when the content is cached on the cache server.

The instructions may further cause the cache server to: request validation of the user session token at an authentication server, when the user session token is not already cached on the cache server; and cache the validated user session token on the cache server.

The instructions may further cause the cache server to: retrieve the content from a content server, when the content is not already cached on the cache server; and cache the retrieved content on the cache server.

The cached content may be provided with a freshness time stamp. The requested content may then be retrieved from the content server when the freshness time stamp has expired or when not already stored on the cache server.

Determination if the requested content is cached on the cache server may be executed after determination if the user session token is cached on the cache server.

The user session token may be cached on the cache server independently from the cached content on the cache server.

The CD may be a User Equipment, UE, and the cache server may be a video cache server.

According to a third aspect, it is presented a cache server configured to manage a content request from a Communication device, CD. The cache server comprises: a communication manager for receiving a request for a content from the CD, the request further comprising a user session token; and configured to provide the requested content to the CD when the user session token is cached on the cache server and when the content is cached on the cache server.

The cache server may further comprise: a cache mechanism manager for requesting validation of the user session token at an authentication server, when the user session token is not already cached on the cache server; and to cache the validated user session token on the cache server; and/or for retrieving the content from a content server, when the content is not already cached on the cache server; and to cache the retrieved content on the cache server.

According to a fourth aspect, it is presented a computer program for managing a content request from a Communication device, CD. The computer program comprising computer program code which, when run on a cache server, causes the cache server to: receive a request for a content from the CD, the request further comprising a user session token; and provide the requested content to the CD when the user session token is cached on the cache server and when the content is cached on the cache server.

According to a fifth aspect, it is present a computer program product comprising a computer program and a computer readable storage means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment where embodiments presented herein can be applied;

FIG. 2 is a schematic diagram illustrating details of structures for restricted content for an embodiment presented herein;

FIG. 3 is a schematic diagram illustrating some components of a cache server;

FIGS. 4A-4C are flow charts illustrating methods for embodiments presented herein;

FIG. 5 is a schematic diagram illustrating a location where a cache server may be implemented; and

FIG. 6 is a schematic diagram showing functional modules of a cache server.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

A problem with existing solutions for cache servers, providing restricted content, is that two or more requests are required: one request for cache user authentication data and another request for content data; which slows down access to restricted content. Existing solutions further need to validate authenticated sessions in a backend system for every request, again slowing down access to restricted content.

This solution is based on a cache server and a method, respectively, that enables double caching upon a single content request from a user.

By allowing a caching mechanism on a cache server to restart, an unauthenticated session can, after the end user has been authenticated (and cached), be used to fetch the requested content without a subsequent request from the end user. This makes is possible to cache both the authenticated session and the requested content within the same end user request. Any new requests from the end user, after this end user already have had the authentication session cached, thus offload work from an authentication backend to the cache server.

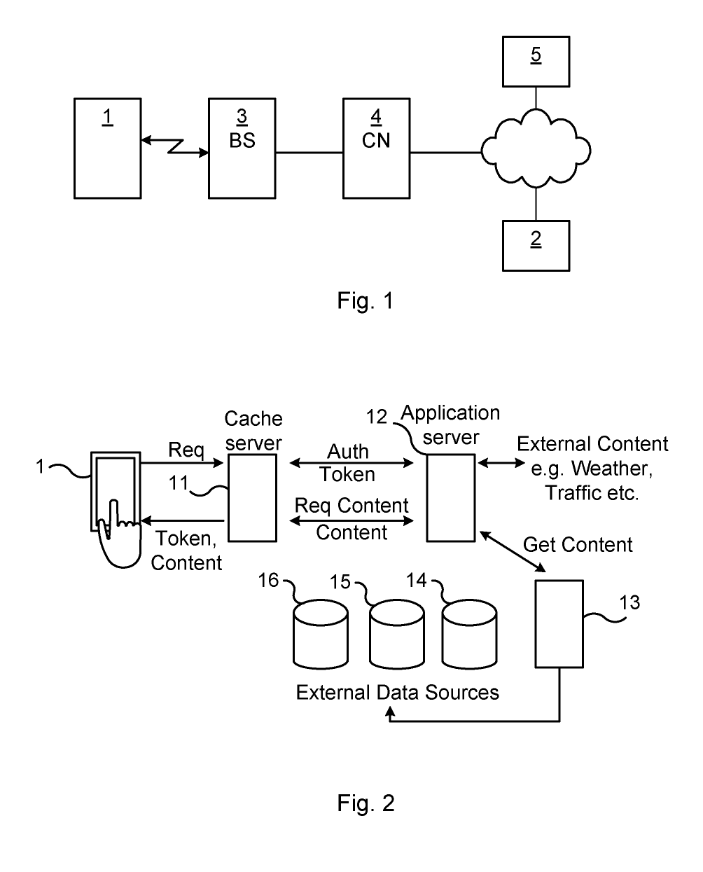

The environment for embodiments presented herein is illustrated in FIG. 1. A user may request content items e.g. through a cellular network. The user, having a wireless Communication Device, CD, such as User Equipment, UE, 1, is in connectivity with a base station 3, such as an eNodeB in a Long Term Evolution (LTE) access network connected to a core network 4. The core network 3 is in turn connected to Internet. The term wireless UE may be or alternatively be termed as a mobile communication terminal, communication device, mobile terminal, user terminal, user agent, machine-to-machine device etc., and can be, for example, what today are commonly known as a smartphone or a tablet/laptop with wireless connectivity. The CD 1 may also be a telematics unit embedded in a vehicle such as a car, bus and truck, and be connected to a vehicle-internal network for exchange of e.g. vehicle or driver data with a fleet management system connected to the vehicle via Internet. The CD 1 may also be a unit mounted in a dashboard of a vehicle for displaying information and communicating with the driver or passengers of the vehicle and being connected to a telematics unit embedded in the vehicle.

A user may also request content items e.g. through a fixed network. The user, then having a fixed CD 2, is connected to Internet. The term fixed CD may be or alternatively be termed as a computer, a set top box, Internet Protocol Television (IP TV), or an IP compatible device.

A user, having a fixed, or a wireless, CD 1 or 2 can in this environment request downloading of contents from a cache server. The cache server has connection to the Internet. The cache server may be a video cache server.

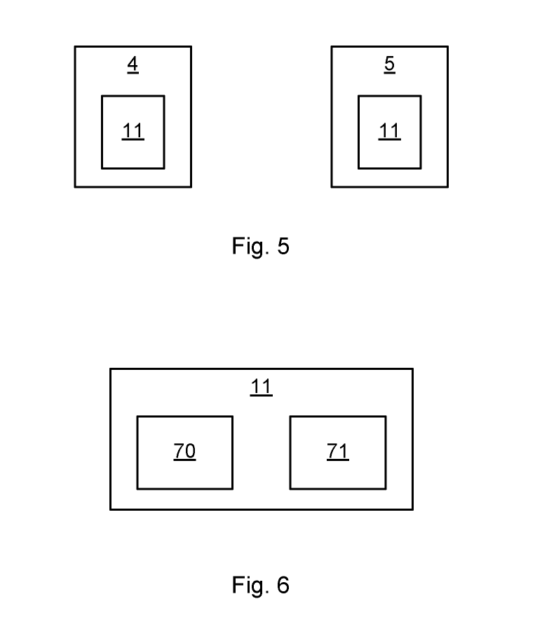

As illustrated in FIG. 5, the cache server 11 may be implemented in dedicated cache server 5 connected to the Internet (or in a virtual cache server 5 arbitrarily arranged in the Internet), or in the core network 4 of the cellular system. In a cellular system, it is particularly advantageous to have a cache server 11 arranged as closed to the wireless CD 1 as possible, to minimize unnecessary communication.

Details of signaling between different parts handling content items are illustrated in FIG. 2. Illustration is only shown for a CD in the form of a wireless CD 1, since handling of content items is the same for a fixed CD 2.

A solution for accessing restricted content may comprise the following components: a client application, a caching server 11, an authentication and content server 12, and one or more content server(s) 13 and external databases 14-16. The solution providing the possibility of maximizing the amount of cached data on the cache server and minimizing calls to a back end system, by caching of both authenticated user sessions data (token) and content data upon a single content request from a user.

With the user session token as well as the requested content stored on the cache server 11, a user may download restricted content items even if a backend authentication system goes down.

The user requests, through a web browser or an app of the CD 1, a content item from a cache server 11, e.g via an HTTP request (url (to server), content_id, user_id, token) or via an API native message. The cache server 11 starts a caching mechanism for a user authorization session and contacts an application server 12, e.g. with a request, e.g. an HTTP request, to get a user session token for the user, providing an identifier, e.g. a user name, user code, an email address, an IP address, an IMEI and IMSI, and a password for the user. The application server 12 returns a validated user session token to the cache server 11, which stores it. The cache server 11 then restarts the caching mechanism, this time for the requested content item, and contacts the application server 12, e.g. via an HTTP request, providing the user session token and an identifier for the content item, such as an URL (Uniform Resource Locator). The application server 12 may directly have access to the requested content item, or it may get it from a separate content server 13, which in turn may get it from external sources/databases 14-16. The application server 12 may also get external content related to the requested content item, such as weather information, traffic information, etc. The application server 12 then returns the requested content item to the cache server 11. The cache server 11 stored the requested content item, and returns the requested content item and the user session token to the CD 1.

The cache server 11 may work as a state machine. The CD 1 having two states: a first state having a user session token, or a second state not having a user session token.

A CD 1 in the first state may provide a user name and a password in a header of a request to the cache server 11. These are validated in the application server 12, and a user session token is returned to be saved by the cache server 11 and further returned to the CD 1.

A CD 1 in the second state may send the user session token as a Hypertext Transfer Protocol (HTTP) cookie in a HTTP request to the cache server 11. The cookie may be sent as a header with a value or together with cookie-meta data.

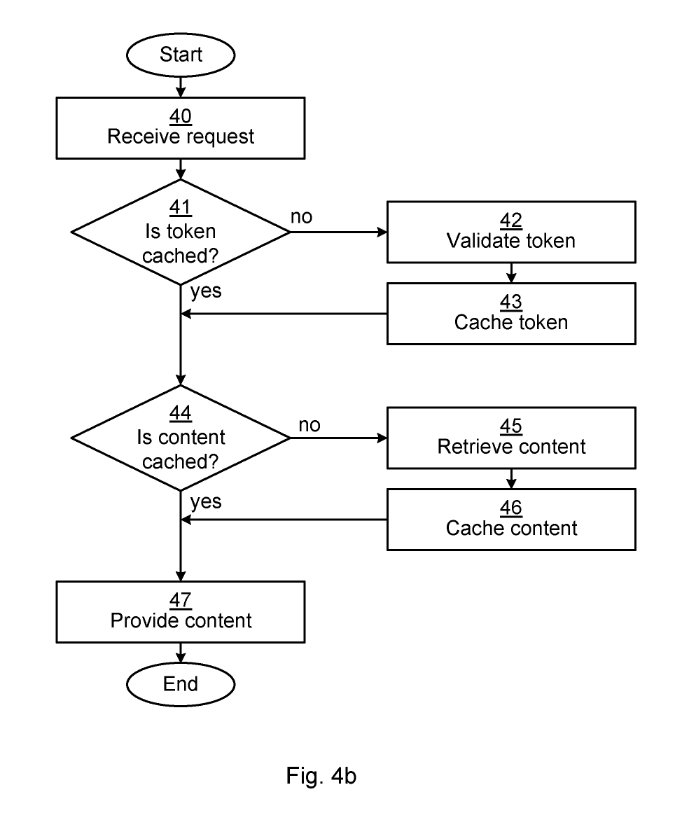

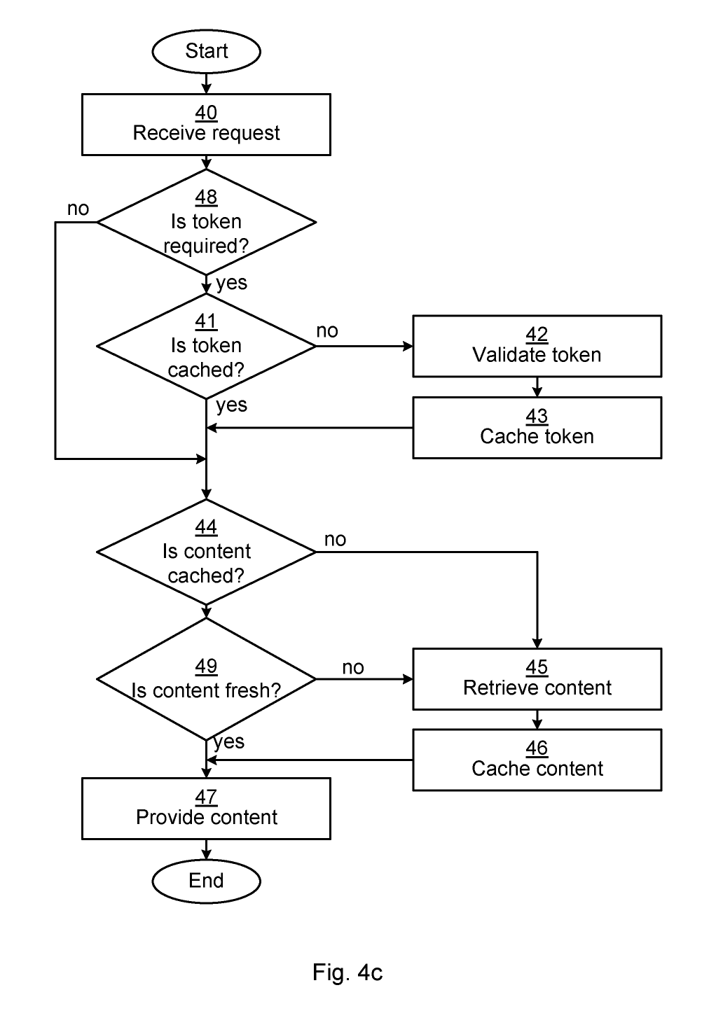

A method, according to an embodiment, for managing a content request from a CD 1 is presented with reference to FIG. 4A, which method is performed by a cache server 11. The method comprises the steps of receiving 40 a request for a content from a CD 1, the request further comprising a user session token; and providing 47 the requested content to the CD 1 when 41 the user session token is cached on the cache server and when 44 the content is cached on the cache server 11.

The method may comprise further steps, illustrated in FIG. 4B. When a request has been received 40 at the cache server 11, it is checked 41 if a user session token is stored on the cache server 11 or not, for the user requesting the content. Further, a request may comprise a user name and a password when the CD 1 not yet has a user session token.

If a user session token is stored on the cache server 11, the cache server 11 thereafter checks 44 if the requested content is stored on the cache server 11 or not. If a user session token, on the other hand, is not already cached on the cache server 11, the cache server 11 request validation 42 of the user session token at the application server 12. When the user session token has been validated by the application server 12, the cache server 11 stores 43 the validated user session token on the cache server 11. The cache server 11 then proceeds to check 44 if the requested content is stored on the cache server or not.

If the requested content is stored on the cache server 11, the cache server 11 thereafter provides 17 the requested content to the CD 1, together with the user session token for future content requests from the user. If requested content, on the other hand, is not already cached on the cache server 11, the cache server 11 retrieves 45, e.g. via an HTTP request, the requested content from the application server 12, by providing the user session token. When the requested content has been retrieved e.g. via an HTTP request, from the application server 12, the cache server 11 stores 46 the requested content on the cache server 11. The cache server 11 then proceeds to provide 47 the requested content to the CD 1.

The authentication process, wherein the validity of the user session token is checked, may be fully separate from content item process, wherein the requested content is provided to the user, such that two different users can download the same content item in parallel. The user session token is thus independently stored from the content item, on the cache server 11.

The method may comprise further steps, illustrated in FIG. 4C. When the cache server 11 receives 40 a request for a content item, the cache server 11 checks 48 if the requested content item is restricted or not, i.e. if a token is required to download the content item. If a token is not required, the caching mechanism continues by checking if the content item is cached on the server or not, and if a token is required to download the content item, the caching mechanism continues as described above in connection with FIG. 4B.

Further, when the cache server 11 has determined that the requested content is cached 44 on the cache server 11, the cache server 11 may determine if the cached content is fresh or not 49. If the cached content is determined fresh the caching mechanism continues as described above in connection with FIG. 4B. When the cached content is determined not fresh, the caching mechanism instead continues as if the content is not cached on the cache server 11 and proceeds to retrieve 45 the requested content as described above in connection with FIG. 4B. The content items cached on the cache server 11 may be provided with a freshness time stamp, to determine whether the cached content items are fresh or not.

A suitable time limit for the freshness decision in step 49 may be set in view of the type of content. For e.g. a cross country skiing competition, the following time limits may be set: live data—a few seconds; time for a skier: a few minutes; a final result—hours/days; number of medals—hours/days.

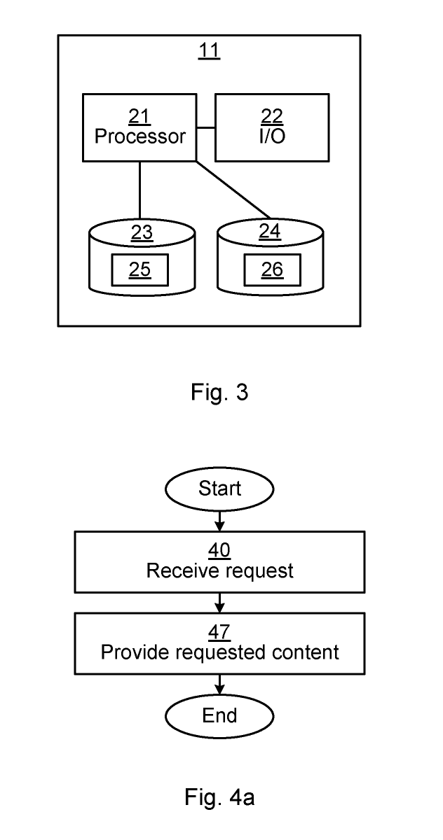

A cache server 11 is presented with reference to FIG. 3, which cache server is configured to manage a content request from a CD 1. The cache server 11 comprises: a processor 21; and a computer program product 23 storing a computer program 25 with instructions that, when executed by the processor 21, causes the cache server 11 to: receive a request for a content from the CD 1, the request further comprising a user session token; and provide the requested content to the CD 1 when the user session token is cached on the cache server and when the content is cached on the cache server.

FIG. 3 is a schematic diagram showing some components of the cache server 11. The processor 21 may be provided using any combination of one or more of a suitable central processing unit (CPU), multiprocessor, microcontroller, digital signal processor (DSP), application specific integrated circuit etc., capable of executing software instructions of a computer program 25 stored in a memory 23. The memory can thus be considered to be or form part of the computer program product 23. The processor 21 may be configured to execute methods described herein with reference to FIGS. 4A-4C.

The memory may be aread and write memory (RAM) or a read only memory (ROM) or any combination thereof. The memory may also comprise persistent storage, which, for example, can be any single one or combination of magnetic memory, optical memory, solid state memory or even remotely mounted memory.

A second computer program product in the form of a data memory 24 may also be provided, e.g. for reading and/or storing data during execution of software instructions in the processor 21. The data memory 24 can be a read and write memory (RAM) or a read only memory (ROM) or any combination thereof, and may also comprise persistent storage, which, for example, can be any single one or combination of magnetic memory, optical memory, solid state memory or even remotely mounted memory. The data memory 24 may e.g. hold other software instructions 26, to improve functionality for the cache server 11.

The cache server 11 may further be caused to request validatation of the user session token at an authentication server 12, when the user session token is not already cached on the cache server 11; and to cache the validated user session token on the cache server 11.

The cache server 11 may also be caused to retrieve the content from a content server 12-16, when the content is not already cached on the cache server 11; and to cache the retrieved content on the cache server 11.

FIG. 6 is a schematic diagram showing functional blocks of the cache server 11. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIGS. 4A-4C, comprising a communication manager/communication manager unit 70 and a cache mechanism manager/cache mechanism manager unit 71. In the embodiments where one or more of the modules are implemented by a computer program, then it shall be understood that these modules do not have to correspond to programming modules, but can be written as instructions according to the programming language in which they would be implemented, since some programming languages do not typically contain programming modules.

The communication manager 70 is for receiving a request for a content from the CD 1, 2, the request further comprising a user session token; and is for providing the requested content to the CD 1, 2 when the user session token is cached on the cache server 11 and when the content is cached on the cache server 11. This module corresponds to the receiving step 40 and the providing step 47 of FIGS. 4A-4C. This module can e.g. be implemented by the processor 21 of FIG. 3, when running the computer program.

The cache mechanism module 71 is for requesting validation of the user session token at an authentication server 12, when the user session token is not already cached on the cache server 11; and to cache the validated user session token on the cache server 11; and/or for retrieving the content from a content server 12-16, when the content is not already cached on the cache server 11; and for caching the retrieved content on the cache server 11. This module corresponds to the determination step 41, the request validation step 42, the caching step 43, the determination step 44, the retrieving step 45, the caching step 46, the determination step 48, and the determination step 49 of FIGS. 4A-4C. This module can e.g. be implemented by the processor 21 of FIG. 3, when running the computer program.

The invention has mainly been described above with reference to a few embodiments. However, as is readily appreciated by a person skilled in the art, other embodiments than the ones disclosed above are equally possible within the scope of the invention, as defined by the appended patent claims.

1. A method for managing a content request from a Communication device, CD, the method being performed by a cache server and comprising the steps of:
receiving a request for a content from a Communication device, CD, the request further comprising a user session token; and
providing the requested content to the CD when both the user session token and the content are cached on the cache server.

2. The method according to claim 1, further comprising the steps of:
requesting validation of the user session token at an authentication server, when the user session token is not already cached on the cache server; and
caching the validated user session token on the cache server.

3. The method according to claim 1, further comprising the steps of:
retrieving the content from a content server, when the content is not already cached on the cache server; and
caching the retrieved content on the cache server.

4. The method according to claim 3, wherein the cached content is provided with a freshness time stamp.

5. The method according to claim 4, wherein the requested content is retrieved from the content server when the freshness time stamp has expired or when not already cached on the cache server.

6. The method according to claim 1, wherein determination if the requested content is cached on the cache server in the step of providing is performed after determination if the user session token is cached on the cache server in the step of providing.

7. The method according to claim 1, wherein the user session token is cached on the cache server independently from the cached content on the cache server.

8. The method according to claim 1, wherein the CD is a User Equipment, UE, and the cache server is a video cache server.

9. A cache server configured to manage a content request from a Communication Device, CD, the cache server comprising:
a processor; and
a computer program product storing instructions that, when executed by the processor, causes the cache server to:
receive a request for a content from the CD, the request further comprising a user session token; and
provide the requested content to the CD when both the user session token and the content are cached on the cache server.

10. The cache server according to claim 9, wherein the instructions further causes the cache server to:
request a validation of the user session token at an authentication server, when the user session token is not already cached on the cache server; and
cache the validated user session token on the cache server.

11. The cache server according to claim 9, wherein the instructions further cause the cache server to:
retrieve the content from a content server, when the content is not already cached on the cache server; and
cache the retrieved content on the cache server.

12. The cache server according to claim 11, wherein the cached content is provided with a freshness time stamp.

13. The cache server according to claim 12, wherein the requested content is retrieved from the content server when the freshness time stamp has expired or when not already stored on the cache server.

14. The cache server according to claim 9, wherein determination if the requested content is cached on the cache server is executed after determination if the user session token is cached on the cache server.

15. The cache server according to claim 9, wherein the user session token is cached on the cache server independently from the cached content on the cache server.

16. The cache server according to claim 9, wherein the CD is a User Equipment, UE, and the cache server is a video cache server.

17.-19. (canceled)

20. A computer program product for managing a content request from a Communication Device, CD, said computer program product comprising a computer program and a computer readable storage means on which the computer program is stored, said computer program comprising computer program code which, when run on a cache server, causes the cache server to:
receive a request for a content from the CD, the request further comprising a user session token; and
provide the requested content to the CD when both the user session token and the content are cached on the cache server.
